(19) United States
(12) Patent Application Publication
(10) Pub. No.: US 2026/0165284 A1
(43) Pub. Date: Jun. 18, 2026

(54) PET TRAINING PAD DEVICE WITH ODOR-RETAINING TARGET STRUCTURE

(71) Applicant: PERITAS BRANDS, LLC, Niceville, FL (US)

(72) Inventor: Charles Weston DUDLEY, Destin, FL (US)

(73) Assignee: PERITAS BRANDS, LLC, Niceville, FL (US)

(21) Appl. No.: 18/980,901

(22) Filed: Dec. 13, 2024

(51) Int. Cl. A01K 1/01

(52) U.S. Cl. CPC A01K 1/0107; A01K 1/01577

(57) ABSTRACT

A pet training pad device may include a pad body and a target structure disposed on an upper surface of the pad body. The pad body may include an absorbent layer for absorbing a target substance. The target structure may be configured to retain a target odor from the target substance. The target structure may include an odor-retaining layer for absorbing and retaining the target odor from the target substance, and a padding layer provided below the odor-retaining layer and above the upper surface of the pad body.

### FIELD

The present disclosure generally relates to pet products. More particularly, the present disclosure relates to a pet training pad device having an odor-retaining target structure.

### BACKGROUND

Pet waste collection pads, commonly referred to as “potty sheets” or “training pads,” are widely used for indoor pet waste management, particularly for dogs. These pads are generally available in single-use, disposable types as well as washable, reusable varieties. Despite the convenience offered by these products, pet owners often face significant challenges when training pets to consistently use the pads. One of the primary difficulties is encouraging the pet to associate the pad with a designated elimination area, especially in cases where pets are accustomed to outdoor environments or have not been previously trained to use such pads. Pets may avoid the pad, exhibit inconsistent behavior, or use it incorrectly, leading to accidents outside the intended area. Additionally, the scent, size, and placement of the pad can greatly influence a pet's willingness to use it, with some pets showing reluctance or confusion even after extended periods of training. These challenges highlight the need for improved design solutions to make pet waste collection pads more effective and easier to use for both pets and owners.

### SUMMARY

Aspects of the disclosure relate to a pet training pad device having a pad body and a target structure disposed on an upper surface of the pad body. The pad body may have an absorbent layer for absorbing a target substance. The target structure may be configured to retain a target odor from the target substance. As an example, the target substance may include urine produced by the pet, and the target odor may include the urine odor of the urine produced by the pet. The target structure may include a porous layer at least partially permeable by the target substance, an odor-retaining layer provided below the porous layer for absorbing and retaining the target odor from the target substance, and a padding layer provided below the porous layer and above the upper surface of the pad body. The target substance may be applied to the target structure by a user from a substance source external to the pad body. The target odor applied to the pad body may serve to encourage a pet to eliminate on the pad body, thereby reducing the occurrence of accidents and need for cleanup while facilitating pet waste elimination behavioral conditioning.

According to an aspect of the present disclosure, a pet training pad device includes: a pad body that includes an absorbent layer for absorbing a target substance; and a target structure disposed on an upper surface of the pad body and configured to retain a target odor from the target substance, wherein the target structure includes: an odor-retaining layer for absorbing and retaining the target odor from the target substance; and a padding layer provided below the odor-retaining layer and above the upper surface of the pad body.

According to an embodiment of any paragraph(s) of this summary, the target structure further comprises a porous layer at least partially permeable by the target substance provided above the odor-retaining layer and the padding layer.

According to an aspect of the present disclosure, a pet training pad device includes: a pad body that includes an absorbent layer for absorbing a target substance; and a target structure disposed on an upper surface of the pad body and configured to retain a target odor from the target substance, wherein the target structure includes: a porous layer at least partially permeable by the target substance; an odor-retaining layer provided below the porous layer for absorbing and retaining the target odor from the target substance; and a padding layer provided below the porous layer and above the upper surface of the pad body.

According to an embodiment of any paragraph(s) of this summary, the target substance includes a substance produced by a pet.

According to an embodiment of any paragraph(s) of this summary, the target substance includes pet urine produced by the pet.

According to an embodiment of any paragraph(s) of this summary, the target substance is applied to the target structure by a user from a substance source located externally to the pad body.

According to an embodiment of any paragraph(s) of this summary, the substance source includes a second pad body on which the target substance has been deposited.

According to an embodiment of any paragraph(s) of this summary, the pad body and the target structure are constructed from washable materials such that the pet training pad device is washable.

According to an embodiment of any paragraph(s) of this summary, the target structure has a height in a vertical direction perpendicular to the upper surface of the pad body that satisfies a predetermined height threshold range between 1 and 5 centimeters.

According to an embodiment of any paragraph(s) of this summary, the target structure is provided in a central region of the upper surface of the pad body.

According to an embodiment of any paragraph(s) of this summary, the target structure has a brightness value (L*) ranging from 0 to 100, a green-red component (a*) value of 0, and a blue-yellow component (b*) value ranging from −128 to 0 in an L*a*b color system.

According to an embodiment of any paragraph(s) of this summary, the target structure has a brightness value (L*) ranging from 0 to 100, a green-red component (a*) value of 0, and a blue-yellow component (b*) value ranging from 0 to 128 in an L*a*b color system.

According to an embodiment of any paragraph(s) of this summary, the target structure is operably coupled to the pad body by a set of fasteners.

According to an embodiment of any paragraph(s) of this summary, the target structure is removably attached to the pad body.

According to an embodiment of any paragraph(s) of this summary, the target structure is removably attached to the pad body by hook-and-loop fasteners.

According to embodiments, an aspect of the present disclosure relates to a pet training pad device use method for a pet training pad device including: a pad body that includes an absorbent layer for absorbing a target substance; and a target structure disposed on an upper surface of the pad body and configured to retain a target odor from the target substance, wherein the target structure includes: a porous layer at least partially permeable by the target substance, an odor-retaining layer provided below the porous layer for absorbing and retaining the target odor from the target substance, and a padding layer provided below the porous layer and above the upper surface of the pad body, the pet training pad device use method including: collecting, from a substance source using an odor applicator, the target substance; and bringing the odor applicator into physical contact with the target structure to transfer the target odor from the target substance to the target structure.

According to an embodiment of any paragraph(s) of this summary, the odor applicator includes a second pad body on which the target substance has been deposited.

According to an embodiment of any paragraph(s) of this summary, the target substance is pet urine produced by a pet.

According to an embodiment of any paragraph(s) of this summary, the target structure has a height in a vertical direction perpendicular to the upper surface of the pad body that satisfies a predetermined height threshold range of 1 to 3 centimeters.

According to an embodiment of any paragraph(s) of this summary, the pet training pad device use method further includes positioning the target structure at a desired location on the upper surface of the pad body; and attaching the target structure to the upper surface of the pad body at the desired location using a set of fasteners.

According to an embodiment of any paragraph(s) of this summary, the pet training pad device use method further includes washing the pet training pad to remove the target odor from the target structure.

According to embodiments, an aspect of the present disclosure relates to a pet training pad device including a pad body that includes an absorbent layer for absorbing a target substance; and a target structure disposed on an upper surface of the pad body and configured to retain a target odor from the target substance, wherein: the target structure includes: a porous layer at least partially permeable by the target substance, an odor-retaining layer provided below the porous layer for absorbing and retaining the target odor from the target substance, and a padding layer provided below the porous layer and above the upper surface of the pad body; the target substance is pet urine applied to the target structure by a user from a substance source located externally to the pad body; and the pad body and the target structure are constructed from washable material such that the pet training pad device is washable.

The above summary is not intended to describe each illustrated embodiment or every implementation of the present disclosure.

### BRIEF DESCRIPTION OF THE DRAWINGS

The accompanying drawings, which are incorporated in and constitute a part of the specification, illustrate various example systems, methods, and so on, that illustrate various example embodiments of aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

FIG. 1 illustrates a perspective view of a pet training pad device when viewed obliquely from above, according to the embodiments of the present disclosure.

FIG. 2 illustrates a perspective view of the pet training pad device when viewed from the side, according to the embodiments of the present disclosure.

FIG. 3 illustrates an example of a structure of a pad body according to the embodiments of the present disclosure.

FIG. 4 illustrates an exploded view of the layers included in the target structure of the pet training pad device, according to the embodiments of the present disclosure.

FIG. 5 illustrates an example of the pet training pad device in a state in which the target structure is removed from the pad body, according to the embodiments of the present disclosure.

FIG. 6 illustrates an example of transferring a target odor from a target substance to the target structure of the pet training pad device, according to the embodiments of the present disclosure.

FIG. 7 illustrates a first example of a target structure according to the embodiments of the present disclosure.

FIG. 8 illustrates a second example of a target structure according to the embodiments of the present disclosure.

### DETAILED DESCRIPTION

Hereinafter, embodiments of the present disclosure will be described with reference to the accompanying drawings. It should be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure. Additionally, it should be noted in the following description that the same reference numerals in different embodiments denote the same or similar features.

As described herein, pet owners often face significant challenges when training pets to consistently use waste collection pads. One of the primary difficulties is encouraging the pet to associate the pad with a designated elimination area, especially in cases where pets are accustomed to outdoor environments or have not been previously trained to use such pads. Conventionally, some disposable waste collection pads have been impregnated with various artificial or natural scents in an attempt to encourage pets to eliminate on the pad. These scents are typically designed to mimic pheromones or other odors that are thought to attract pets to the area. While such scents have some level of effectiveness, they are usually impregnated into the sheet during manufacturing and are generally limited to use with disposable-type waste pads.

Further, it has been observed that the most effective scent for incentivizing a pet to eliminate on a waste collection pad is the scent of the pet's own bodily substances, such as the pet's own urine. This natural scent acts as a powerful trigger for the pet's instinctive behavior to eliminate in familiar or marked areas. Accordingly, aspects of the present disclosure relate to a pet training pad device that facilitates the transfer and retention of the pet's own odor onto a washable, reusable pad body. Such a pad may better leverage the pet's instinctive responses, aiding in behavioral conditioning and improving the success of house training by making the pad more appealing for repeated waste elimination while also providing economic and environmental benefits due to pad reusability.

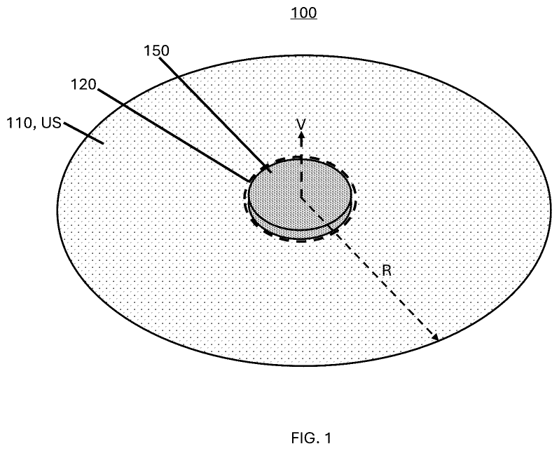

Turning now to the figures, FIGS. 1-5 illustrate various views of a pet training pad device 100 according to the embodiments of the present disclosure. Herein, for convenience of description, elements present in multiple views will be collectively described with reference to the figures. It should be noted that, for convenience of explanation, while some of the embodiments of the present disclosure will be described with reference to examples illustrating a substantially circular pet training pad device 100 as illustrated in FIGS. 1-5, the present disclosure is not limited thereto, and the pet training pad device 100 may be provided in a variety of shapes and sizes. Accordingly, the various terminology related to circles (e.g., radius, diameter, circumference) used in description of the circular pet training pad device 100 shown in the examples will be understood to be interchangeable with corresponding terminology (e.g., width, length, perimeter) for other suitable geometric configurations.

With regard to directions, herein, aspects of the disclosure will be described with reference to directions defined relative to the pet training pad device 100. As illustrated in FIG. 1, a direction extending outward from the center point of the pet training pad device 100 is referred to as the radial direction R, and the height direction of the pet training pad device 100 (e.g., a direction perpendicular to the plane of the surface on which the pet training pad device 100 rests) is referred to as the vertical direction V.

FIG. 1 illustrates a perspective view of a pet training pad device when viewed obliquely from above. As illustrated in FIG. 1, the pet training pad device 100 primarily includes a pad body 110 and a target structure 150 disposed on an upper surface US of the pad body 110.

In general, the pad body 110 refers to a mat, sheet, or pad for absorbing and containing pet waste. The pad body 110 may take any size and shape suitable for pet elimination training. For example, as illustrated in the Figures, in embodiments, the pad body 110 may be generally circular in shape, but the pad body 110 is not limited thereto, and may be rectangular, triangular, elliptical or any other suitable shape. Similarly, the size of the pad body 110 is not particularly limited herein and may be provided in a variety of sizes suitable for use by a variety of types of animals. As examples, in embodiments, when provided in a generally circular shape, the pad body 110 may have a radius between 76 centimeters and 183 centimeters. Alternatively, when provided in a generally rectangular shape, the pad body 110 may be provided with dimensions of 76×81 centimeters (30×32 inches), 91×86 centimeters (36×34 inches), or 183×183 centimeters (72×72 inches), for example. The pad body 110 may have a thickness of approximately 2.5 millimeters, although the present disclosure is not limited herein and the thickness may vary based on the content and structure of the individual layers constituting the pad body 110.

In general, the target structure 150 refers to a structural member for absorbing and retaining a target odor from a target substance. The target structure 150 may take any size and shape suitable for elimination training. For example, as illustrated in the Figures, in embodiments, the target structure 150 may have a generally disk-like shape (e.g., be a disk or “puck”), but the target structure 150 is not limited thereto, and may be rectangular, triangular, elliptical or any other suitable shape. Similarly, the size of the target structure 150 is not particularly limited herein and may be provided in a variety of sizes suitable for use by a variety of types of animals. As examples, in embodiments, when provided in a generally disk-like shape, the target structure 150 may have a radius between 2.5 and 15 centimeters and a height in the vertical direction V of 2 centimeters, although the present disclosure is not limited herein and the dimensions of the target structure 150 may vary based on the structure of the individual layers constituting the target structure 150.

In embodiments, the target structure 150 may be fixedly attached to the pad body 110 via a set of fasteners 120. As an example, the target structure 150 may be joined to the pad body 110 by a set of fasteners such as stitches around its perimeter (e.g., circumference). In certain embodiments, the target structure 150 may be removably attached to the pad body 110. For example, the target structure 150 may be removably attached to the pad body 110 via hook and loop fasteners. In embodiments, aspects of the present disclosure relate to the recognition that it may be preferable to attach the target structure 150 to a central region of the upper surface US of the pad body 110 to encourage the pet to eliminate in the central region of the pet training pad device 100, reducing the risk of accidents and need for cleanup. Here, the central region of the pet training pad device 100 refers to a region of the pad body 110 within a predetermined radius (e.g., 2 centimeters, 4 centimeters, 6 centimeters) from a central coordinate of the pad body 110.

In the present disclosure, the target substance referred to herein may include any substance having an odor detectable by a pet. More particularly, the target substance includes a bodily substance produced by the pet that is desired to use (e.g., being trained to use) the training pad device 100. For example, the target substance may include urine, feces, or other substance (e.g., saliva, vomit) produced by the pet. It should be noted that here, the target substance is preferably a bodily substance produced particularly by the pet to be trained, and not merely a substance that mimics the general chemical characteristics of a substance produced by a pet. By using a target substance produced by the pet to be trained, it is possible to capture a target odor having olfactory characteristics unique to the bodily substances produced by the pet and increase the effectiveness of behavioral conditioning. Accordingly, it will be understood that the target odor refers to an odor characteristic to the target substance. For instance, in the case that the target substance is pet urine, the target odor may be a urine odor.

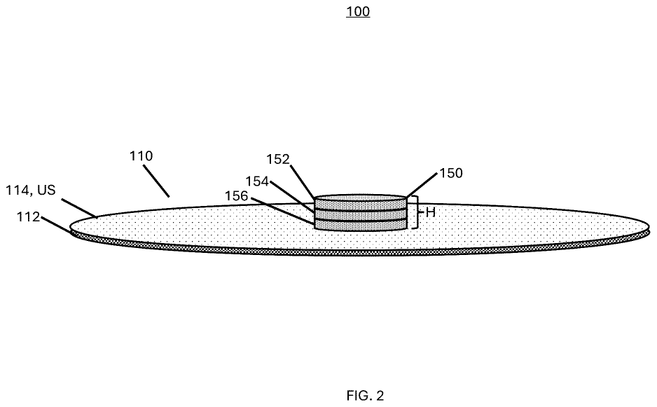

FIG. 2 illustrates a perspective view of the pet training pad device 100 when viewed from the side, according to the embodiments of the present disclosure. As illustrated in FIG. 2, both the pad body 110 and the target structure 150 disposed on the upper surface US of the pad body 110 may have a multi-layer structure including a plurality of layers of different materials.

As illustrated in FIG. 2, the pad body 110 may include an impermeable layer 112 and an absorbent layer 114 (e.g., an absorbent layer). The impermeable layer 112 may include a material layer that is substantially impervious to fluids. As examples, the impermeable layer 112 may be formed from thermoplastic polyurethane, polyvinyl chloride, nylon or polyester with a waterproof coating, or other suitable fluid impervious material. The impermeable layer 112 may function to prevent liquid or semi-solid substances (e.g., excrement from a pet) from soaking through the pad body 110 and leaking onto the surface (e.g., floor) on which the pad body 110 is located. In embodiments, the lower surface of the impermeable layer 112 (e.g., the surface of the pad body 110 opposite the upper surface US and in contact with the floor) may be provided with one or more anti-slip members. The anti-slip members may include raised silicon bumps, polyvinyl chloride bumps, fabric, adhesive, or the like. The anti-slip members may reduce slippage of the pad body 110 while in use.

The absorbent layer 114 of the pad body 110 may include a material layer for absorbing and retaining fluids. As examples, the absorbent layer 114 may be formed from polyester fiber, microfiber, cotton, rayon, sponge, foam or any other suitable absorbent material. The absorbent layer 114 may function to capture and retain liquid or semi-solid substances (e.g., excrement from a pet). In embodiments, the absorbent layer 114 may be impregnated with a scent to attract pets. In certain embodiments, the absorbent layer 14 may include activated carbon, sodium bicarbonate, zeolite, antimicrobial agents, essential oils, plant extracts, cyclodextrins, citric acid, odor absorbing polymers, enzymes, or the like to neutralize odors.

As used herein, the term “absorbent” may refer to the characteristic of a substance to retain moisture. Accordingly, in the present disclosure, absorbency may include absorbency by hydrophilic materials that trap liquid through molecular bonding (e.g., trapping water by coordinating it with polar hydrogen bonds) as well as hydrophobic materials (e.g., polyester) that capture liquid in entropic pockets (e.g., trapping water by holding it in entropic pockets within a non-polar/hydrophobic material).

As illustrated in FIG. 2, the absorbent layer 114 may be provided above the impermeable layer 112 in the vertical direction V so as to overlay the impermeable layer 112. In embodiments, the size of the impermeable layer 112 may be substantially similar to the size of the absorbent layer 114. The impermeable layer 112 may be attached to the absorbent layer 114 such that the absorbent layer 114 and the impermeable layer 112 are bonded together. The absorbent layer 114 may be attached to the impermeable layer 112 via one or more layer bonding techniques such as adhesive bonding, stitching (e.g., with polyester or nylon stitches), fasteners, or the like. Additionally, the edges of the absorbent layer 114 and the impermeable layer 112 may be sealed together using adhesives, stitching (e.g., with polyester or nylon stitches), or fasteners to prevent leakage from the edges of the pad body 110. It will be understood that here, the absorbent layer 114 constitutes the upper surface US of the pad body 110. It will further be understood that the pet training pad device 100 is generally intended to be used in an orientation with the upper surface US facing upward in the vertical direction V, such that target substances (e.g., excrement) deposited on the pad body 110 may be substantially absorbed by the absorbent layer 114.

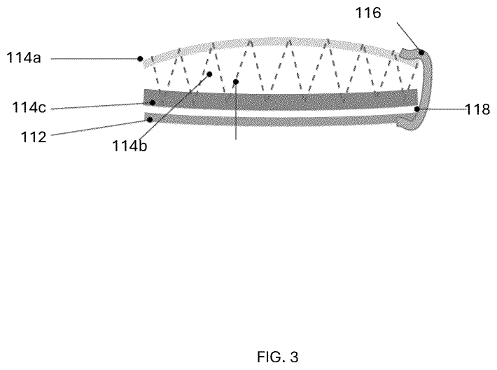

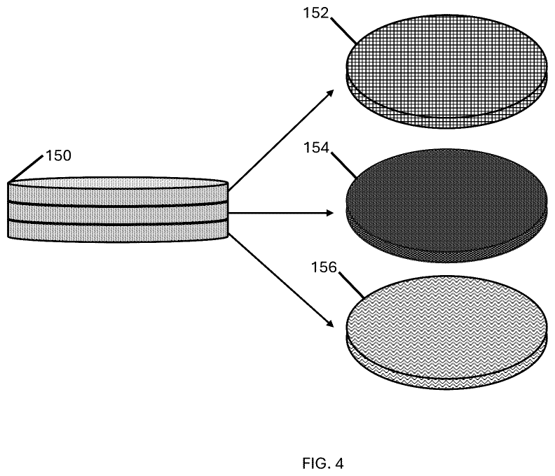

As illustrated in FIG. 2, the target structure 150 may have a multilayer structure including a plurality of layers of different materials. In embodiments, the target structure 150 may include a porous layer 152, an odor-retaining layer 154, and a padding layer 156. In certain embodiments, the porous layer 152 may be omitted, such that the target structure 150 includes the odor-retaining layer 154 and the padding layer 156. The porous layer 152 may be located above the odor-retaining layer 154 in the vertical direction V, and the odor-retaining layer 154 may be located above the padding layer 156 in the vertical direction V, such that the porous layer 152 corresponds to an upper layer, the odor-retaining layer 154 corresponds to an intermediate layer, and the padding layer 156 corresponds to a lower layer of the target structure 150. In embodiments, each layer may be a physically distinct, physically separate layer. However, the multilayer configuration of the target structure 150 is not limited thereto, and the order, position, number, type, and material of each layer may be modified. For instance, in embodiments, one or more of the layers may be combined into a single layer. As an example, the odor-retaining layer 154 and the padding layer 156 may be implemented as a single combined layer. As an additional example, in embodiments, an additional waterproof/impermeable layer may be provided on the bottom of the target structure 150 to reduce the amount of liquid that passes through the target structure 150 to the pad body 110. As a detailed explanation of the layers constituting the target structure 150 will be described with reference to FIGS. 3 and 4 herein, an explanation thereof will be omitted here.

In embodiments, as illustrated in FIG. 2, the target structure 150 may have a height H in the vertical direction V that achieves a predetermined height threshold range of 1 to 5 centimeters. That is, the odor applicator 150 may protrude above the upper surface US of the pad body 110 by a predetermined distance equal to the height H. In embodiments, the predetermined height threshold range may be set by the manufacturer to a value based on the type of pet envisioned to use the pet training pad device 100. For instance, the predetermined height threshold range may be set to a higher value in cases in which the pet training pad device 100 will be used by larger breeds of dogs, and the predetermined height threshold range may be set to a lower value in cases in which the pet training pad device 100 will be used by smaller breeds of dogs. As an example, in embodiments, the predetermined height threshold range may be set to a value between 1 and 5 centimeters (0.39 inches to 1.96 inches). In certain embodiments, the predetermined height threshold range may be set to a value between 1 and 3 centimeters. In certain embodiments, the predetermined height threshold range may be set to a value between 1.5 and 2.5 centimeters. In embodiments, the desired height H of the odor applicator 150 may be achieved by increasing the thickness of the padding layer 156. Providing the target structure 150 with a height in the vertical direction V that achieves a predetermined height threshold range may increase the visibility of the target structure 150 and further encourage pets to perform elimination on the pad body 110 in the vicinity of the target structure 150, while maintaining a height low enough that pets may easily walk over the target structure 150.

In embodiments, aspects of the present disclosure relate to the recognition that some domesticated animal breeds (e.g., dogs) have substantially dichromatic vision, such that they perceive their surroundings in hues of two colors. Accordingly, aspects of the disclosure relate to providing the target structure 150 in a color that may be easily discerned by dichromatic animals such as dogs. For instance, as blue and yellow have been identified as colors that may be easily discerned by some dichromatic animals, in embodiments, the target structure 150 may be provided in a generally blue or yellow color. More particularly, in certain embodiments, the target structure 150 may have a brightness value (L*) ranging from 0 to 100, a green-red component (a*) value of 0, and a blue-yellow component (b*) value ranging from −128 to 0 in an L*a*b color system to provide the target structure 150 with a generally blue color. In certain embodiments, the target structure 150 may have a brightness value (L*) ranging from 0 to 100, a green-red component (a*) value of 0, and a blue-yellow component (b*) value ranging from 0 to 128 in an L*a*b color system to provide the target structure 150 with a generally yellow color.

In certain embodiments, the target structure 150 may have a high-contrast color pattern, such as black and white or blue and white. In certain embodiments, the target structure 150 and the pad body 110 may be provided in contrasting colors (e.g., black or blue pad body 110 and yellow or white target structure 150). In this way, it may be possible to facilitate visual identification of the target structure 150 by dichromatic animals to further encourage elimination near the target structure 150.

In certain embodiments, the target structure 150 may be provided with a textured fabric such as corduroy or fleece. Provided the target structure 150 with a textured fabric such as corduroy or fleece may facilitate the creation of shadows, enhancing visual interest in the target structure 150 by the pet. In certain embodiments, the target structure 150 may be provided using a reflective or shiny fabric to enhance visual interest in the target structure 150 by the pet.

In embodiments, the pad body 110 and the target structure 150 described herein may be constructed from washable materials such that the pet training pad device 100 is washable. Here, “washable” refers to the characteristic of the pet training pad device 100 to withstand multiple cleaning cycles (e.g., handwashing or wash and dry cycles in a standard washing/drying machine) without degradation in functionality or integrity. That is, the pad body 110 and the target structure 150 may be made from materials that can withstand laundering processes including handwashing or machine-washing without losing shape, color, or texture. Accordingly, as described herein, materials for both the pad body 110 and the layers of the target structure 150 may be selected that are suitable for washing (e.g., handwashing or machine washing). For example, the pad body 110 and the layers of the target structure 150 may be constructed from washable materials such as 3D air mesh, polyester, nylon, viscose fabric, polypropylene, polyurethane, natural fibers (e.g., cotton), PVC, spandex, polyester spandex blends, elastane, Lycra (registered trademark), activated carbon, or other synthetic or natural fibers, or a combination thereof. It will be understood, however, that the present disclosure is not limited hereto, and the aspects of the present disclosure are equally applicable to a pet training pad device 100 constructed from lightweight, low-cost materials and designed to be disposed of or discarded after a limited number of uses.

In embodiments, the target structure 150 may be constructed from materials configured to release (e.g., surrender) the target odor from the target structure 150 when washed. As examples, the target structure 150 may be constructed from polyester, nylon, polyurethane laminated fabrics, bamboo charcoal fabrics, cotton-based wadding, fleece, or a combination thereof. In this way, the target structure 150 can be washed to remove the target odor from the target structure. In other embodiments, the target structure 150 may be configured to retain the target odor after washing. For example, the target structure 150 may be constructed from a wool blend, nonwoven polypropylene fabric, absorbent cellulose-based material (e.g., rayon, viscose), a material with an odor-retaining coating (e.g., zeolites or activated carbon), specially treated polyurethane materials, or a combination thereof. In this way, the target structure 150 can retain the target odor through washing and reduce the need to apply the target substance after each wash.

In embodiments, the materials for the pad body 110 and the target structure 150 may be selected to control the amount of liquid that passes through the target structure 150 and into the pad body 110. For instance, in embodiments, low absorbency materials may be used for the target structure 150 and high absorbency materials may be used for the pad body 110 to allow a large portion (e.g., greater than 50%, greater than 75%, greater than 90%) of the liquid that contacts the target structure 150 to pass through the target structure 150 to the pad body 110 and be absorbed by the pad body 110 such that a relatively small portion (e.g., less than 50%, less than 25%, less than 10%) remains in the target structure 150. In certain embodiments, high absorbency materials may be used for the target structure 150 to retain a large portion (e.g., greater than 50%, greater than 75%, greater than 90%) of the liquid that contacts the target structure 150 in the target structure 150. In embodiments, a waterproof/impermeable layer may be provided on the bottom of the target structure 150 to reduce the amount of liquid that passes through the target structure 150 to the pad body 110.

FIG. 3 illustrates an example of a structure of a pad body 110 according to the embodiments of the present disclosure. As described herein, the pad body 110 may include an impermeable layer 112 and an absorbent layer 114 (e.g., an absorbent layer). Further, in certain embodiments, the absorbent layer 114 may include a moisture wicking sub-layer 114a, a spacer sub-layer 114b, and an absorbent sub-layer 114c. The moisture wicking sub-layer 114a may be configured to direct moisture from the upper surface of the pad body 110 into the lower layers of the pad body 110. The moisture wicking sub-layer 114a may be formed of polyester. The spacer sub-layer 114 may be configured to create a buffer (e.g., of air or other material) between the moisture wicking sub-layer 114a and the absorbent sub-layer 114c. This spacer sub-layer may serve to separate the moisture absorbed in the absorbent sub-layer 114c from the upper surface of the pad body 110 in contact with the feet of the pet, thereby facilitating hygiene, cleanliness, and comfort of the pet. The spacer sub-layer 114 may be formed from a polyester spray-bonded wadding or the like.

In embodiments, the moisture wicking sub-layer 114a, the spacer sub-layer 114b, and the absorbent sub-layer 114c may be bonded together with stitching, embossing, or lamination, and may not impinge upon (e.g., intrude into, penetrate into) the impermeable layer 112. Further, in embodiments, a laminate layer 118 may be provided between the absorbent sub-layer 114c and the impermeable layer 112. In embodiments, a periphery attachment 116, such as trim, may be provided at the edges of the pad body 110 to bind together the respective edges of the moisture wicking sub-layer 114a, the spacer sub-layer 114b, the absorbent sub-layer 114c and the impermeable layer 112.

According to the configuration described above, it is possible to provide a pad body 110 capable of facilitating absorbency with respect to a target substance that is washable by hand or in a standard washing/drying machine.

FIG. 4 illustrates an exploded view of the layers included in the target structure 150 of the pet training pad device 100, according to the embodiments of the present disclosure. As described herein, the target structure 150 may have a multilayer structure including a porous layer 152, an odor-retaining layer 154, and a padding layer 156.

Here, the porous layer 152 refers to a material layer configured to be at least partially permeable by a target substance (e.g., pet urine). The porous nature of the porous layer 152 may facilitate penetration of the target substance through the porous layer 152 and into the odor-retaining layer 154. In embodiments, the porous layer 152 may be formed from 3D air mesh, polyester, nylon, viscose fabric, polypropylene, polyurethane, natural fibers (e.g., cotton), PVC, spandex, polyester spandex blends, elastane, Lycra (registered trademark), activated carbon, or other synthetic or natural fibers, or a combination thereof.

The odor-retaining layer 154 refers to a material layer configured to absorb and retain a target odor (e.g., a urine odor) from the target substance (e.g., pet urine). The odor-retaining layer 154 may be provided below the porous layer 152 such that the target substance that penetrates the porous layer 152 reaches and is absorbed by the odor-retaining layer 154. The odor-retaining layer 154 may be configured to retain the target odor over a prolonged period of time (e.g., several days, a week or more) to incentivize pets to eliminate on the target structure 150. In embodiments, the odor-retaining layer 154 may be formed from 3D air mesh, polyester, nylon, viscose fabric, polypropylene, polyurethane, natural fibers (e.g., cotton), PVC, spandex, polyester spandex blends, elastane, Lycra (registered trademark), activated carbon, or other synthetic or natural fibers, or a combination thereof. Preferably, the odor-retaining layer 154 may be formed from absorbent, polymer-based materials with microscopic structures optimized for odor entrapment. Such materials may incorporate odor-binding agents, such as activated carbon or specific synthetic polymers, which chemically or physically bind to odor molecules, thus preventing rapid dissipation of the scent. By retaining the target odor in the odor-retaining layer 154 for an extended duration, the odor retaining layer 154 helps condition the pet's behavior by creating a persistent scent marker, guiding the pet back to the pad for future use.

More particularly, with regard to materials for the odor-retaining layer 154, materials such as synthetic fabrics, spandex or Lycra (registered trademark), acrylic, wool, rayon, or natural fibers like cotton may be preferably used. Synthetic fabrics such as polyester and nylon are petroleum-based and hydrophobic, which causes them to trap oils and other liquids (e.g., pet urine) and promote odor-causing bacteria, thereby leading to longer odor retention. Similarly, spandex, Lycra (registered trademark), acrylic, wool, or rayon also provide high absorbency and facilitate odor-retention. In certain embodiments, the target structure 150 may be constructed from materials such as synthetic fabrics (e.g., polyester, nylon) or acrylic such that the target structure 150 is configured to retain the target odor even after washing (e.g., the target odor remains on the target structure 150 even through washing). In certain embodiments, the target structure 150 may be constructed from materials such as cotton such that the target odor 150 can be easily removed from the target structure 150 by washing.

The padding layer 156 refers to a material layer for providing cushioning and structural definition to the target structure 150. The padding layer 156 may be provided below the porous layer and above the upper surface US of the pad body 110. The padding layer 156 may be implemented as a wadding, stuffing, packing, or other fill material for providing additional height and cushioning to the target structure 150. As described herein, the thickness of the padding layer 156 may be suitably adjusted to configure the target structure to have a height H in the vertical direction V that achieves a predetermined height threshold range (e.g., 1 to 5 centimeters, 1 to 3 centimeters, 1.5 to 2.5 centimeters). Providing the target structure 150 with a height in the vertical direction V that achieves a predetermined height threshold range may increase the visibility of the target structure 150 and further encourage pets to perform elimination on the pad body 110 in the vicinity of the target structure 150 while allowing pets to easily walk over the target structure 150. In embodiments, the padding layer 156 may be formed from polyester fill, polypropylene fill (e.g., polypropylene cotton), polyester, nylon, viscose fabric, activated carbon, natural fibers (e.g., cotton) or other synthetic or natural fibers, or a combination thereof. Providing the padding layer 156 below the odor-retaining layer 154 in the target structure 150 may promote even distribution of fluids within the odor-retaining layer 154, enhancing the effectiveness of the odor-retaining layer by preventing saturation in specific areas. In embodiments, the padding layer 156 and the odor-retaining layer 154 may be combined together and implemented as a single odor-retaining padding layer.

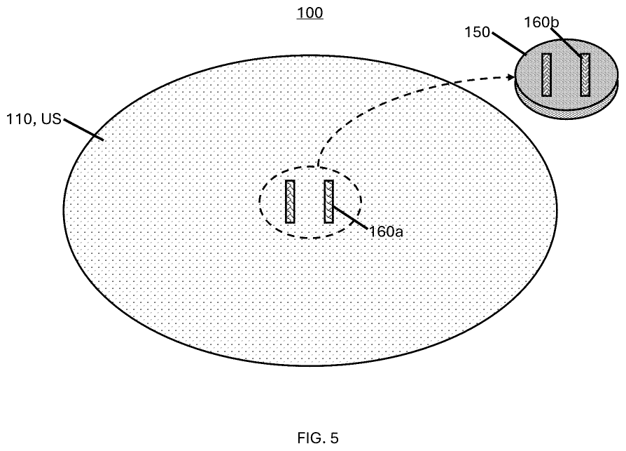

FIG. 5 illustrates an example of the pet training pad device 100 in a state in which the target structure 150 is removed from the pad body 110, according to the embodiments of the present disclosure. Aspects of the disclosure relate to the recognition that, in certain embodiments, it may be preferable to remove the target structure 150 from the pad body 110. For example, in certain situations, it may be desirable to remove the target structure 150 for separate washing or cleaning, for facilitating application of a target substance, or for using the target structure 150 to which a target substance (e.g., pet urine) has been applied in another location. Accordingly, in embodiments, the target structure 150 may be configured to be removably attached to the pad body 110. For example, as illustrated in FIG. 5, the target structure 150 and the pad body 110 may be provided with a set of hook and loop fasteners 160a, 160b to facilitate removable attachment of the target structure to the pad body 110. In certain embodiments, one portion of the hook and loop fasteners 160a, 160b (e.g., loops 160a) may be provided on a region (e.g., the central region) of the upper surface US of the pad body 110, and another portion of the hook and loop fasteners (e.g., the hooks 160b) may be provided on a corresponding region on the lower surface (e.g., the lower surface of the padding layer 156) of the target structure 150.

In certain embodiments, the target structure 150 may be provided with hook fasteners 160b (e.g., plastic or polypropylene hooks) on its lower surface that are configured to removably couple with the material of the upper surface US of the pad body 110, such that the target structure 150 may attach to the upper surface US of the pad body 110 without the need for loops 160a provided on the pad body 110. In this way, the target structure 150 may be freely positioned at a desired location on the pad body 110. Here, the hook fasteners 160b may include polypropylene or plastic hooks.

By configuring the target structure 150 to be removably attached to the pad body 110, it may be possible to facilitate ease of washing and promote flexibility in pet training methods by allowing the target structure 150 to which a target substance (e.g., pet urine) has been applied to be used in a location other than the pad body 110.

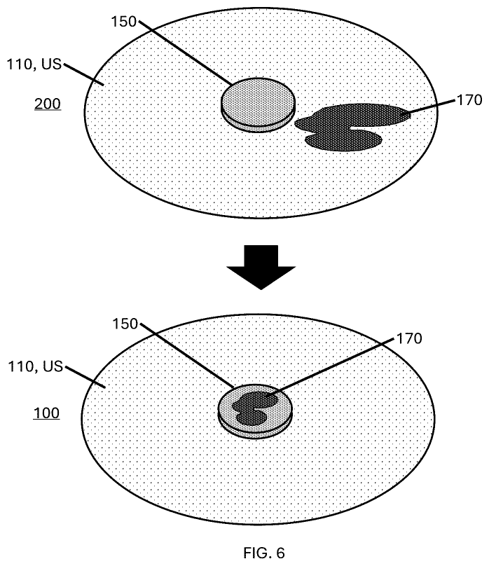

FIG. 6 illustrates an example of transferring a target odor from a target substance 170 to the target structure 150 of the pet training pad device 110, according to the embodiments of the present disclosure. As described herein, the target substance 170 may include any substance having an odor detectable by a pet, and preferably includes urine, feces, or other substance (e.g., saliva, vomit) produced by the pet. It should be noted that for convenience of explanation, FIG. 6 illustrates an example in which the target substance 170 is collected from a pet training pad device 200. Here, the pet training pad device 200 may be another (e.g., a second) pet training pad device on which the target substance 170 has been deposited. That is, the pet training pad device 200 is a separate pet training pad device from the clean, unused pet training pad device 100 illustrated in FIGS. 1-2. It will be understood, however, that the substance source from which the target substance 170 is collected is not limited to the pet training pad device 200 and may be any location on which the target substance 170 has been deposited. For instance, in embodiments, the substance source may include a location external to the pet training pad device 100 such as a floor, ground, or wall on which the target substance 170 has been deposited. It should be noted that, as the pet training pad device 200 has the same structure as the pet training pad device 100 described herein, a redundant description thereof will be omitted, and the same reference numerals will be used with respect to the components of the pet training pad device 200.

After the target substance 170 has been deposited on a surface accessible to the user (e.g., caretaker of a pet) such as the upper surface US of the pad body 110 of the pet training pad device 200, the user may transfer a target odor from the target substance 170 to the target structure 150. Here, transferring the target odor from the target substance 170 to the target structure 150 may include dabbing, blotting, rubbing, immersing, patting, swabbing, touching, or otherwise bringing the target structure 150 into physical contact with the target substance such that the target odor of the target substance 170 is absorbed into the odor retention layer 154 of the target structure 150. In embodiments, the user may bring the pad body 110 of the pet training pad device 200 on which the target substance 170 has been deposited to the pet training pad device 100, and dab or rub the pet training pad device 200 onto the target structure of the pet training pad device 100 to transfer the target substance 170 and the target odor thereof to the target structure 150 of the pet training pad device 100. In embodiments, the user may bring the pet training pad device 100 to the pad body 110 of the pet training pad device 200 on which the target substance 170 has been deposited, and dab or rub the target structure 150 of the pet training pad device 100 onto the target substance 170 deposited on the pet training pad device 200 to transfer the target substance 170 and the target odor thereof to the target structure 150 of the pet training pad device 100. As an example, as illustrated in FIG. 6, in the case that the target substance 170 is pet urine deposited on a pet training pad device 200 (e.g., a soiled, second pet training pad device), the user may bring the target structure 150 of the pet training pad device 100 into physical contact with the pet urine on the pet training pad device 200 to apply the pet urine and the urine smell thereof to the target structure 150 of the pet training pad device 100.

In certain embodiments, in a configuration in which the target structure 150 is removably attached to the pad body 110 of the training pad device 100, the user may remove the target structure 150 from the pad body 110 of the training pad device 100 and bring the target structure 150 into physical contact with the target substance 170 to transfer the target substance 170 and the target odor thereof to the target structure 150 of the pet training pad device 100. In certain embodiments, the user may use an odor applicator to collect the target substance 170 from a substance source (e.g., the floor, the wall, another pet training pad) and apply it to the target structure 150 of the pet training pad device 100. Here, the odor applicator 150 refers to any structure for facilitating transfer of a target odor from the target substance 170 to the target structure 150 of the pet training pad device 100.

Once the target substance 170 and the target odor thereof have been transferred to the target structure 150 of the pet training pad device 100, the pet training pad device 100 may be used in an orientation where the target structure 150 to which the target substance 170 has been applied faces upward in the vertical direction V. As described herein, by transferring a target odor such as a urine odor from urine produced by the pet to the target structure 150 of the pad body 110 of the pet training pad device 100, the pheromones included in the urine odor may be effective to incentivize the pet to eliminate on the pad body 110 in the region in which the target structure 150 is located. As described herein, in embodiments, aspects of the present disclosure relate to the recognition that it may be preferable to provide the target structure 150 to a central region of the upper surface US of the pad body 110 to encourage the pet to eliminate in the central region of the pet training pad device 100, reducing the risk of accidents and need for cleanup. Here, the central region of the pet training pad device 100 refers to a region of the pet training pad within a predetermined radius (e.g., 2 centimeters, 4 centimeters, 6 centimeters) from a central coordinate of the pet training pad device 100.

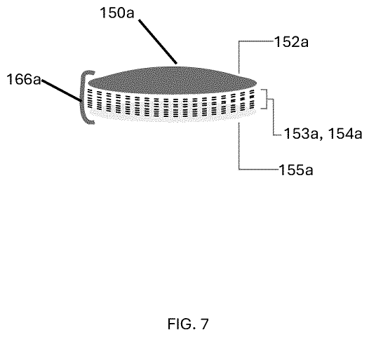

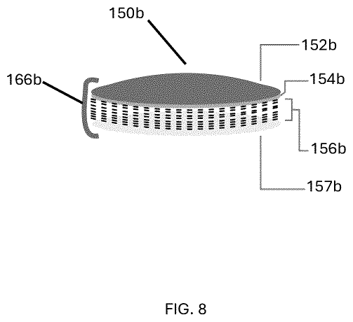

Next, with reference to FIGS. 7-8, a series of examples of the target structure 150 will be described. It will be understood that the examples of the target structure 150a-b described below are provided for illustrative purposes only, and the target structure 150 according to the present disclosure is not limited to any particular example. Additionally, for convenience of explanation, an explanation of redundant aspects of the target structure 150 will be omitted herein, but it will be understood that the various components and features of the examples provided below may be suitably combined with the features of any of the other embodiments or examples provided herein.

FIG. 7 illustrates a first example of a target structure 150a according to the embodiments of the present disclosure. In embodiments, the target structure 150a may include a porous layer 152a, a first containing layer 153a, an odor retention padding layer 154a, and a second containing layer 155a.

The porous layer 152a may include a material layer configured to be at least partially permeable by a target substance (e.g., pet urine) to facilitate moisture wicking of the target substance to the lower layers of the target structure 150a. The first containing layer 153a may include a material layer for suppressing the material of the odor retention padding layer 154a from penetrating upward through the holes in the porous layer 152a. It should be noted that the first containing layer 153a need not be provided in all cases, depending on the material used for the odor retention padding layer 154a and the size of the holes of the porous layer 152a. In embodiments, both the porous layer 152a and the first containing layer 153a may be formed from 3D air mesh, polyester, nylon, viscose fabric, polypropylene, polyurethane, natural fibers (e.g., cotton), PVC, spandex, polyester spandex blends, elastane, Lycra (registered trademark), activated carbon, or other synthetic or natural fibers, or a combination thereof.

The odor retention padding layer 154a may include a material layer configured to absorb and retain a target odor (e.g., a urine odor) from a target substance (e.g., pet urine) while also providing cushioning and structural definition to the target structure 150 (e.g., a combination of the above-described odor retention layer 154 and padding layer 156). In embodiments, the odor retention padding layer 154a may be implemented using an activated carbon infused polyester wadding. However, the present disclosure is not limited herein, and the odor retention padding layer 154a may be formed from polyester fill, polypropylene fill (e.g., polypropylene cotton), polyester, nylon, viscose fabric, activated carbon, natural fibers (e.g., cotton) or other synthetic or natural fibers, or a combination thereof.

The second containing layer 155a may include a material layer for holding the material of the odor retention padding layer 154a within the target structure 150a. In embodiments, the second containing layer 155a may be formed from 3D air mesh, polyester, nylon, viscose fabric, polypropylene, polyurethane, natural fibers (e.g., cotton), PVC, spandex, polyester spandex blends, elastane, Lycra (registered trademark), activated carbon, or other synthetic or natural fibers, or a combination thereof.

In embodiments, a periphery attachment 166a, such as a trim portion (e.g., periphery stitching), may be provided at the edges of the target structure 150a to bind together the respective edges of each layer.

FIG. 8 illustrates a first example of a target structure 150b according to the embodiments of the present disclosure. In embodiments, the target structure 150b may include a porous layer 152a, an odor retention layer 154b, a padding layer 156b, and a containing layer 157b.

The porous layer 152b may include a material layer configured to be at least partially permeable by a target substance (e.g., pet urine) to facilitate moisture wicking of the target substance to the lower layers of the target structure 150b. In embodiments, the porous layer 152b may be formed from 3D air mesh, polyester, nylon, viscose fabric, polypropylene, polyurethane, natural fibers (e.g., cotton), PVC, spandex, polyester spandex blends, elastane, Lycra (registered trademark), activated carbon, or other synthetic or natural fibers, or a combination thereof. The odor-retaining layer 154b refers to a material layer configured to absorb and retain a target odor (e.g., a urine odor) from the target substance (e.g., pet urine). In embodiments, the odor-retaining layer 154b may be formed from 3D air mesh, polyester, nylon, viscose fabric, polypropylene, polyurethane, natural fibers (e.g., cotton), PVC, spandex, polyester spandex blends, elastane, Lycra (registered trademark), activated carbon, or other synthetic or natural fibers, or a combination thereof.

The padding layer 156b may include a material layer for providing cushioning and structural definition to the target structure 150b. The padding layer 156 may be implemented as a wadding, stuffing, packing, or other fill material for providing additional height and cushioning to the target structure 150b. In embodiments, the padding layer 156b may be formed from polyester fill, polypropylene fill (e.g., polypropylene cotton), polyester, nylon, viscose fabric, activated carbon, natural fibers (e.g., cotton) or other synthetic or natural fibers, or a combination thereof. The containing layer 157b may include a material layer for holding the material of the padding layer 156b within the target structure 150b. In embodiments, the containing layer 157b may be formed from 3D air mesh, polyester, nylon, viscose fabric, polypropylene, polyurethane, natural fibers (e.g., cotton), PVC, spandex, polyester spandex blends, elastane, Lycra (registered trademark), activated carbon, or other synthetic or natural fibers, or a combination thereof.

In embodiments, a periphery attachment 166b, such as a trim portion (e.g., periphery stitching), may be provided at the edges of the target structure 150b to bind together the respective edges of each layer.

As described herein, aspects of the disclosure relate to a pet training pad device having a pad body and a target structure disposed on an upper surface of the pad body. The pad body may have an absorbent layer for absorbing a target substance. The target structure may be configured to retain a target odor from the target substance. As an example, the target substance may include urine produced by the pet, and the target odor may include the urine odor of the urine produced by the pet. The target structure may include a porous layer at least partially permeable by the target substance, an odor-retaining layer provided below the porous layer for absorbing and retaining the target odor from the target substance, and a padding layer provided below the porous layer and above the upper surface of the pad body. The target substance may be applied to the target structure by a user from a substance source external to the pad body.

According to the pet training pad device described herein, provide a pet training pad device capable of absorbing and retaining a target odor (e.g., a urine odor) from a target substance (e.g., urine produced by the pet) in a target structure provided on the pad body. In this way, a pet's natural instinct to perform elimination in areas associated with the odor of their own excrement may be leveraged to train pets to perform elimination on the pad body, thereby reducing the occurrence of accidents and need for cleanup while facilitating hygienic waste management.

### Definitions

The following includes definitions of selected terms employed herein. The definitions include various examples or forms of components that fall within the scope of a term and that may be used for implementation. The examples are not intended to be limiting. Both singular and plural forms of terms may be within the definitions.

An “operable connection,” or a connection by which entities are “operably connected,” is one in which signals, physical communications, or logical communications may be sent or received. Typically, an operable connection includes a physical interface, an electrical interface, or a data interface, but it is to be noted that an operable connection may include differing combinations of these or other types of connections sufficient to allow operable control. For example, two entities can be operably connected by being able to communicate signals to each other directly or through one or more intermediate entities like a processor, operating system, a logic, software, or other entity. Logical or physical communication channels can be used to create an operable connection.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

While example systems, methods, and so on, have been illustrated by describing examples, and while the examples have been described in considerable detail, it is not the intention of the applicants to restrict or in any way limit scope to such detail. It is, of course, not possible to describe every conceivable combination of components or methodologies for purposes of describing the systems, methods, and so on, described herein. Additional advantages and modifications will readily appear to those skilled in the art. Therefore, the invention is not limited to the specific details, the representative apparatus, and illustrative examples shown and described. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

1. A pet training pad device system comprising:
a pad body that includes an absorbent layer for absorbing a target substance; and
a target structure disposed on an upper surface of the pad body so as to protrude above the upper surface of the pad body by a predetermined distance and configured to retain a target odor from the target substance,
wherein the target structure includes:
an odor-retaining layer for absorbing and retaining the target odor from the target substance; and
a padding layer provided below the odor-retaining layer and above the upper surface of the pad body.

2. The pet training pad device system according to claim 1, wherein the target substance includes a substance produced by a pet.

3. The pet training pad device system according to claim 1, wherein the target structure further comprises a porous layer at least partially permeable by the target substance provided above the odor-retaining layer and the padding layer.

4. The pet training pad device system according to claim 1, wherein the target substance is configured to be applied to the target structure by a user from a substance source located externally to the pad body.

5. The pet training pad device system according to claim 4, wherein the substance source includes a second pad body on which the target substance has been deposited.

6. The pet training pad device system according to claim 1, wherein the pad body and the target structure are constructed from washable materials such that the pet training pad device system is washable.

7. The pet training pad device system according to claim 1, wherein the target structure has a height in a vertical direction perpendicular to the upper surface of the pad body that satisfies a predetermined height threshold range of 1 to 5 centimeters.

8. The pet training pad device system according to claim 1, wherein the target structure is provided in a central region of the upper surface of the pad body.

9. The pet training pad device system according to claim 1, wherein the target structure has a brightness value (L*) ranging from 0 to 100, a green-red component (a*) value of 0, and a blue-yellow component (b*) value ranging from −128 to 0 in an L*a*b color system.

10. The pet training pad device system according to claim 1, wherein the target structure has a brightness value (L*) ranging from 0 to 100, a green-red component (a*) value of 0, and a blue-yellow component (b*) value ranging from 0 to 128 in an L*a*b color system.

11. The pet training pad device system according to claim 1, wherein the target structure is operably coupled to the pad body by a set of fasteners.

12. The pet training pad device system according to claim 1, wherein the target structure is removably attached to the pad body.

13. The pet training pad device system according to claim 11, wherein the target structure is removably attached to the pad body by hook-and-loop fasteners.

14. A pet training pad device use method for a pet training pad device including:
a pad body that includes an absorbent layer for absorbing a target substance; and
a target structure disposed on an upper surface of the pad body so as to protrude above the upper surface of the pad body by a predetermined distance and configured to retain a target odor from the target substance,
wherein the target structure includes:
an odor-retaining layer for absorbing and retaining the target odor from the target substance, and
a padding layer provided below the odor-retaining layer and above the upper surface of the pad body,
the pet training pad device use method comprising:
collecting, from a substance source using an odor applicator, the target substance; and
bringing the odor applicator into physical contact with the target structure to transfer the target odor from the target substance to the target structure.

15. The pet training pad device use method according to claim 14, wherein the odor applicator includes a second pad body on which the target substance has been deposited.

16. The pet training pad device use method according to claim 14, wherein the target substance is pet urine produced by a pet.

17. The pet training pad device use method according to claim 14, wherein the target structure is constructed from materials configured to retain the target odor after washing.

18. The pet training pad device use method according to claim 14, further comprising:
positioning the target structure at a desired location on the upper surface of the pad body; and
attaching the target structure to the upper surface of the pad body at the desired location using a set of fasteners.

19. The pet training pad device use method according to claim 14, wherein:
the target structure is constructed from materials configured to release the target odor when washed; and
the pet training pad device use method further comprises:
washing the pet training pad to remove the target odor from the target structure.

20. A pet training pad device system comprising:
a pad body that includes an absorbent layer for absorbing a target substance; and
a target structure disposed on an upper surface of the pad body so as to protrude above the upper surface of the pad body by a predetermined distance and configured to retain a target odor from the target substance,
wherein:
the target structure includes:
a porous layer at least partially permeable by the target substance,
an odor-retaining layer provided below the porous layer for absorbing and retaining the target odor from the target substance, and
a padding layer provided below the porous layer and above the upper surface of the pad body;
the target substance is pet urine configured to be applied to the target structure by a user from a substance source located externally to the pad body; and
the pad body and the target structure are constructed from washable material such that the pet training pad device is washable.
